(19) United States
(12) Patent Application Publication
(10) Pub. No.: US 2018/0205210 A1
(43) Pub. Date: Jul. 19, 2018

(54) WIRE HOUSING PROTECTOR

(71) Applicant: Sumitomo Wiring Systems, Ltd., Yokkaichi, Mie (JP)

(72) Inventor: Ryo SUENAGA, Yokkaichi, Mie (JP)

(21) Appl. No.: 15/742,256

(22) PCT Filed: Aug. 20, 2015
(86) PCT No.: PCT/JP2015/073369

§ 371 Date: Jan. 5, 2018

(30) Foreign Application Priority Data
Jul. 6, 2015 (JP) 2015-135669

(51) Int. Cl. H02G 3/04; B60R 16/02

(52) U.S. Cl. CPC H02G 3/0437; B60R 16/0215; H02G 3/0406

(57) ABSTRACT

A recessed jig insertion groove that opens in an upper surface of a side wall of a protector body and extends downward is provided in a surface in which an engagement portion in an elastic projecting piece insertion hole is formed, and a jig engagement portion that is located below the upper surface of the side wall of the protector body and which engages a leading end of a jig that has been inserted into the recessed jig insertion groove is provided in an opposing surface of an elastic projecting piece that opposes the recessed jig insertion groove.

### CROSS REFERENCE TO RELATED APPLICATIONS

This application claims the priority of Japanese patent application JP2015-135669 filed on Jul. 6, 2015, the entire contents of which are incorporated herein.

### TECHNICAL FIELD

The present invention relates to a wire housing protector for holding multiple electric wires laid therethrough that are routed inside an automobile or the like.

### BACKGROUND ART

Conventionally, in the electric system of automobiles or the like, multiple routed electric wires are laid through and held within a wire housing protector and secured at suitable locations in order to protect the electric wires from external members that might otherwise interfere with the electric wires and restrict the routing of the electric wires.

Incidentally, as described in JP H06-70415U (Patent Document 1) for example, such a wire housing protector is constituted by a trough-shaped protector body and a lid that covers the upper opening of the protector body. Once multiple electric wires are laid through the protector body, the lid is fixed to the protector body by a locking mechanism that protrudes from a sidewall of the protector body. In this way, the protector is capable of holding the multiple electric wires accommodated therein.

However, wire housing protectors having the foregoing conventional structure have an inherent problem in that, because the locking mechanism protrudes outward from a sidewall of the protector body, some of the capacity of the wire housing portion of the protector body is sacrificed so as to secure space for the locking mechanism. Especially in recent years, the demand for downsizing automobiles has been growing while the quantity of on-vehicle electrical equipment has also been increasing. Accordingly, there is a need to increase the housing space inside the protector body without enlarging the space necessary for mounting the wire housing protector. At times, conventionally structured wire housing protectors have been unable to meet this requirement sufficiently. In particular, there have been cases in which the lid could not easily interlock with the protector body because there were too many electric wires for the capacity of the wire housing protector.

Therefore, the applicant proposed, in JP 2014-82880A (Patent Document 2), a wire housing protector including a locking mechanism that is constituted by an elastic projecting piece that projects from an outer peripheral edge of a lid toward a protector body and an elastic projecting piece insertion hole that passes through the inside of a side wall of the protector body and opens in an upper surface, and in which an engagement protrusion provided at a leading end of the elastic projecting piece that has been inserted into the inside of the elastic projecting piece insertion hole engages with an engagement portion that projects from an inner surface of the elastic projecting piece insertion hole so as to prevent the lid from separating from the protector body. According to such a wire housing protector, because the locking mechanism is provided inside the side wall of the protector body, the side wall of the protector body can be extended to a maximum range of the space that is allowed to mount the wire housing protector, compared with a conventional structure in which the locking mechanism protrudes outward from the side wall of the protector body. Therefore, a dead space around the protector body that occurs due to the locking mechanism that protrudes outward from the side wall can be reduced, and the wire accommodating space in the protector body can be increased.

However, in a structure in which the locking mechanism is provided inside the side wall of the protector body in this way, because the engagement protrusion provided at the leading end of the elastic projecting piece that has been inserted into the inside of the elastic projecting piece insertion hole engages with the engagement portion that projects from the inner surface of the elastic projecting piece insertion hole, it is difficult to access the engagement protrusion and the engagement portion from the outside. Therefore, it has an inherent problem in that, after the engagement protrusion and the engagement portion have engaged, the engagement cannot be released, and the lid cannot be separated from the protector body unless the locking mechanism is broken.

### SUMMARY

The present design has been made in view of the above-described circumstances and, as a solution to the problem, provides a wire housing protector having a new structure that can easily release a locking mechanism even if the locking mechanism is provided inside a side wall of a protector body.

A first aspect of the design provides a wire housing protector including: a protector body extending in the shape of a trough; a lid for covering an upper opening of the protector body; and a locking mechanism for fixedly holding the protector body and the lid. The locking mechanism includes: an elastic projecting piece that protrudes from the lid and is provided with an engagement protrusion at its leading end; and an elastic projecting piece insertion hole that passes through the inside of a side wall of the protector body and opens in an upper surface of the side wall, and includes an engagement portion that engages with the engagement protrusion. The elastic projecting piece can be inserted into the elastic projecting piece insertion hole while the leading end of the elastic projecting piece is pressed toward a side opposite to a side to which the engagement protrusion protrudes, and when the elastic projecting piece elastically returns, the engagement protrusion engages with the engagement portion and the lid is held by the protector body. A recessed jig insertion groove that opens in the upper surface of the side wall of the protector body and extends downward is formed in a surface in which the engagement portion in the elastic projecting piece insertion hole is formed. A jig engagement portion that is located below the upper surface of the side wall of the protector body and which engages a leading end of a jig that has been inserted into the recessed jig insertion groove is provided in an opposing surface of the elastic projecting piece that opposes the recessed jig insertion groove.

According to the present aspect, a recessed jig insertion groove that opens in the upper surface of the side wall of the protector body and extends downward is formed in the surface in which the engagement portion in the elastic projecting piece insertion hole is formed, and the jig engagement portion that is located below the upper surface of the side wall of the protector body and which engages the leading end of the jig that has been inserted into the recessed jig insertion groove is provided in the opposing surface of the elastic projecting piece that opposes the recessed jig insertion groove. A lever can be configured in which the leading end of the jig that has been inserted into the recessed jig insertion groove and has engaged with the jig engagement portion acts as a point of load, the abutting part between the jig and the upper surface of the side wall acts as a fulcrum, and the base end of the jig acts as a point of effort. By merely pushing the base end of the jig downward, the elastic projecting piece can be easily elastically deformed such that the engagement protrusion separates from the engagement portion, that is, such that the engagement protrusion separates from the surface in which the engagement portion is formed according to the principle of lever. As a result, even if the locking mechanism is provided inside the side wall of the protector body in order to increase the wire accommodating space inside the protector body, the locking mechanism can be easily released.

A second aspect of the design provides the wire housing protector according to the first aspect, wherein the jig engagement portion includes a protrusion that protrudes from the opposing surface of the elastic projecting piece toward the surface in which the engagement portion is formed.

According to the present aspect, since the jig engagement portion is configured by the protrusion that protrudes from the opposing surface of the elastic projecting piece toward the surface in which the engagement portion is formed, the leading end of the jig can be arranged under the protrusion and be hooked to a lower surface of the protrusion. Accordingly, the jig can be stably held between the upper surface of the side wall of the protector body and the lower surface of the protrusion, and the force based on the principle of lever can be more effectively exerted to the elastic projecting piece. Also, since the engagement protrusion is originally provided in the opposing surface of the elastic projecting piece, the protrusion can be easily formed in the opposing surface of the elastic projecting piece from a viewpoint of the mold configuration.

A third aspect of the design provides the wire housing protector according to the first or second aspect, wherein the jig engagement portion includes a recess that opens in the opposing surface of the elastic projecting piece.

According to the present aspect, since the jig engagement portion includes the recess that opens in the opposing surface of the elastic projecting piece, the jig engagement portion can be formed while reducing the material cost. Note that the jig engagement portion can be configured by combining the protrusion and the recess according to the second aspect as well, and the engagement retainability of the jig can be improved.

A fourth aspect of the design provides the wire housing protector according to any one of the first to third aspects, wherein a pair of the recessed jig insertion grooves are provided at both end portions in a width direction of the surface in which the engagement portion in the elastic projecting piece insertion hole is formed, and a pair of the jig engagement portions are provided at both end portions in a width direction of the elastic projecting piece.

According to the present aspect, since the pair of recessed jig insertion grooves are provided at both end portions in the width direction of the surface in which the engagement portion in the elastic projecting piece insertion hole is formed, and the pair of jig engagement portions are provided at both end portions in the width direction of the elastic projecting piece. The pressing force by the jig can be exerted on both sides of the elastic projecting piece in the width direction, and as a result, the elastic deformation of the elastic projecting piece so as to separate from the surface in which the engagement portion is formed can be stably caused to occur in the entire portion thereof, and the engagement protrusion can be more securely separated from the engagement portion.

A fifth aspect of the design provides the wire housing protector according to any one of the first to fourth aspects, wherein the elastic projecting piece insertion hole is formed so as to pass through the inside of the side wall of the protector body in a height direction, and a lower end opening of the elastic projecting piece insertion hole opens in a lower surface of the side wall, and the engagement protrusion of the elastic projecting piece includes a sloping surface that slopes obliquely upward from a projecting end surface of the elastic projecting piece, and a recessed jig holding portion is provided in the sloping surface so as to accommodate and hold a leading end of a jig that has been inserted from the lower end opening of the elastic projecting piece insertion hole.

According to the present aspect, since the elastic projecting piece insertion hole is formed so as to pass through the inside of the side wall of the protector body in the height direction, and the lower end opening of the elastic projecting piece insertion hole opens in the lower surface of the side wall, the engagement protrusion can be accessed from this lower end opening. Furthermore, the engagement protrusion is provided with the sloping surface that slopes obliquely upward from the projecting end surface of the elastic projecting piece, and the recessed jig holding portion is provided in the sloping surface so as to accommodate and hold the leading end of the jig that has been inserted from the lower end opening. Accordingly, the leading end of the jig that has been inserted inside the elastic projecting piece insertion hole from the lower end opening can be stably held by the recessed jig holding portion provided in the sloping surface of the engagement protrusion of the elastic projecting piece, and the force applied via the jig can be stably transmitted to the elastic projecting piece. Furthermore, since the recessed jig holding portion is provided in the sloping surface that slopes obliquely upward from the leading end of the elastic projecting piece, the force transmitted from a jig that has been inserted from the lower end opening can be exerted in a direction opposite to the projecting direction of the engagement protrusion using a component force that is orthogonal to the sloping surface, and the external force from the jig can be advantageously exerted to the engagement protrusion in a direction such that the engagement protrusion separates from the engagement portion. As a result, due to the combination of the auxiliary force from above the elastic projecting piece and the auxiliary force from below, the locking mechanism can be released even more easily.

According to the wire housing protector according to the present design, the recessed jig insertion groove that opens in the upper surface of the side wall of the protector body and extends downward is formed in a surface in which the engagement portion in the elastic projecting piece insertion hole is formed, and the jig engagement portion that is located below the upper surface of the side wall of the protector body and which engages a leading end of a jig that has been inserted into the recessed jig insertion groove is provided in an opposing surface of the elastic projecting piece that opposes the recessed jig insertion groove. Therefore, a lever can be configured in which the leading end of the jig that has been inserted into the recessed jig insertion groove and has engaged with the jig engagement portion acts as a point of load, the abutting part between the jig and the upper surface of the side wall of the protector body acts as a fulcrum, and the base end of the jig acts as a point of effort. By merely pushing the base end of the jig downward, the elastic projecting piece can be easily elastically deformed such that the engagement protrusion separates from the engagement portion according to the principle of lever. As a result, even if the locking mechanism is provided inside the side wall of the protector body in order to increase the wire accommodating space inside the protector body, the locking mechanism can be easily released.

### BRIEF DESCRIPTION OF DRAWINGS

FIG. 1 is a general perspective view of a wire housing protector according to a first embodiment.

FIG. 2 is an exploded perspective view of the wire housing protector shown in FIG. 1.

FIG. 3 is an enlarged perspective view of an elastic projecting piece of a lid shown in FIG. 2 viewed from below.

FIG. 4 is a plan view of the wire housing protector shown in FIG. 1.

FIG. 5 is an enlarged cross section taken along line V-V in FIG. 4.

FIG. 6 is an enlarged cross section taken along line VI-VI in FIG. 4.

FIG. 7 is a cross-sectional view illustrating a wire housing protector according to a second embodiment, which corresponds to FIG. 6.

### DESCRIPTION OF EMBODIMENTS

Hereinafter, embodiments of the present design will be described with reference to the drawings.

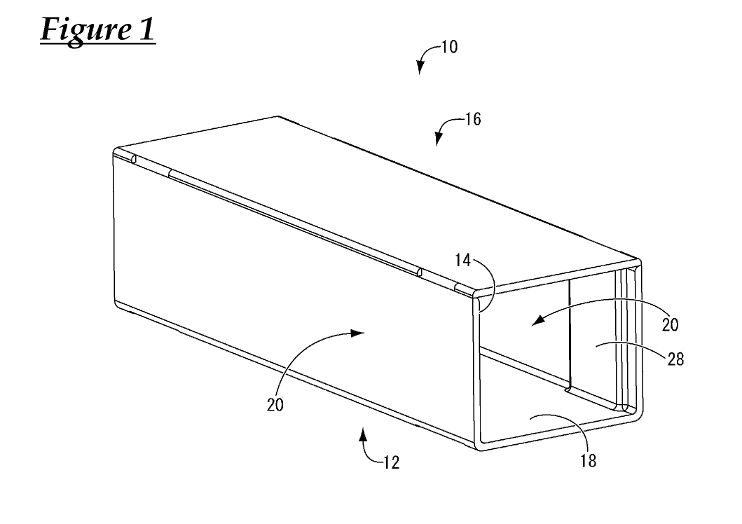

First, a wire housing protector 10 according to a first embodiment is shown in FIGS. 1 to 6. The wire housing protector 10 is constituted by a protector body 12 extending in the shape of a trough and a lid 16 that covers the upper opening 14 of the protector body 12. When in use, the wire housing protector 10 accommodates a wire harness (not shown) laid through the protector body 12. Also, in the following description, “upward” refers to the upward direction in FIG. 1, “downward” refers to the downward direction in FIG. 1, “forward” refers to the leftward direction in FIG. 1, and “backward” refers to the rightward direction in FIG. 1.

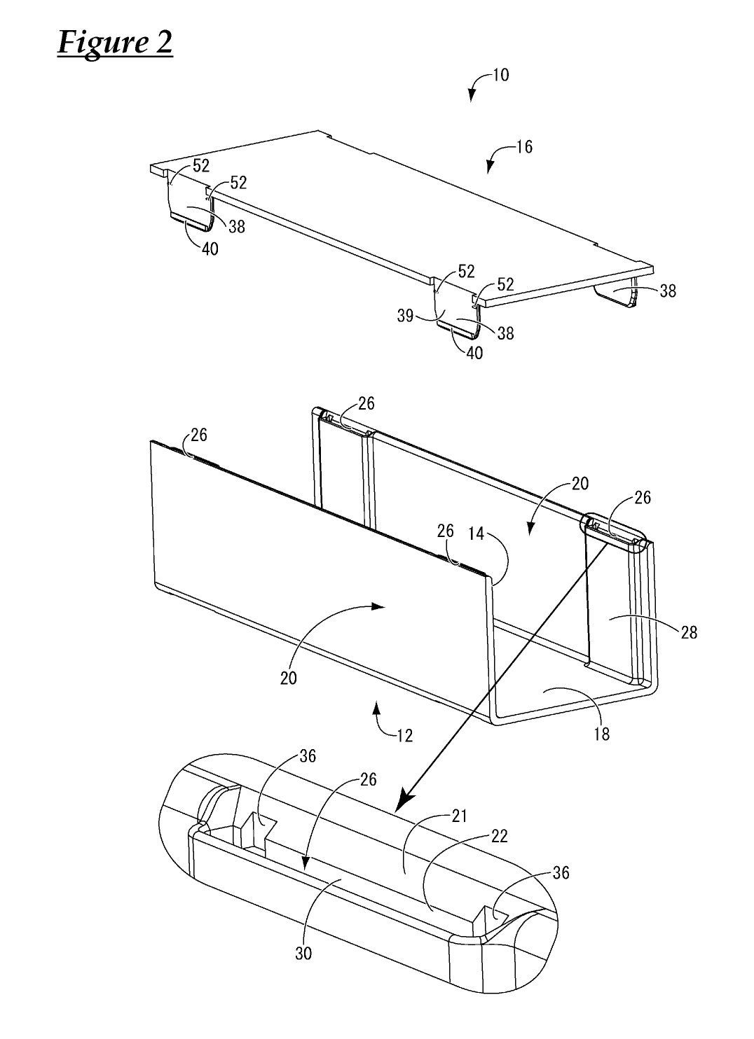

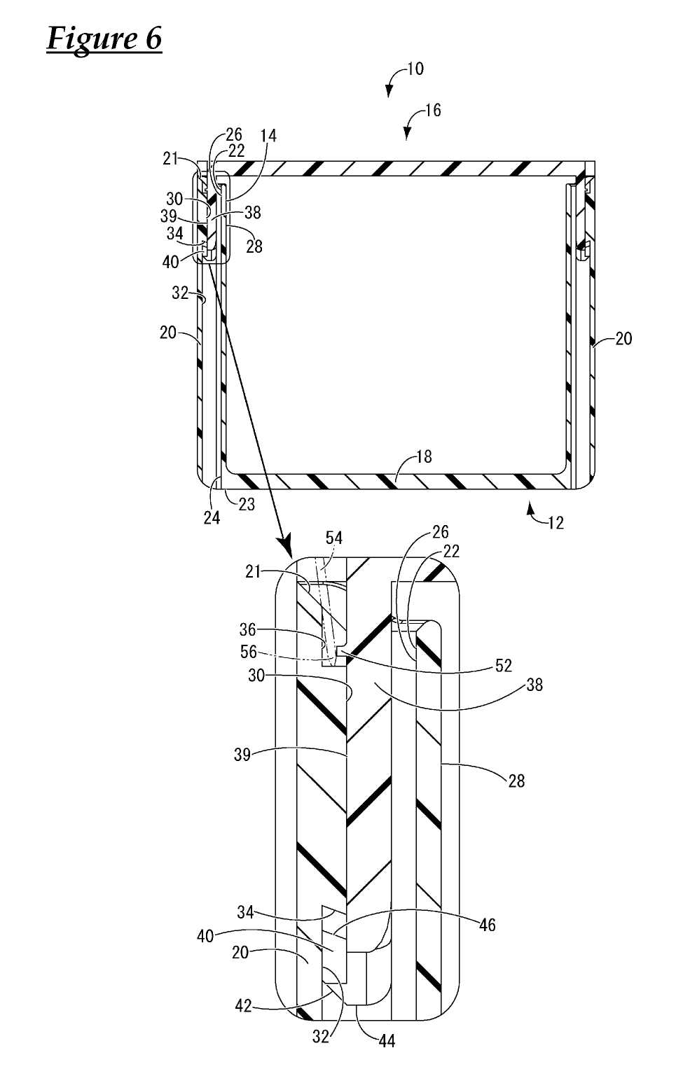

As shown in FIG. 2, the protector body 12 is configured to extend in the shape of a trough, includes a bottom wall 18 and a pair of sidewalls 20 rising upright from both sides of the bottom wall 18, and is integrally formed of synthetic resin such as polypropylene (PP) or polyamide (PA), for example, by injection molding or the like. Also, in the side wall 20 of the protector body 12, elastic projecting piece insertion holes 26 that pass through the inside of the side wall 20 in a height direction are provided. The elastic projecting piece insertion holes 26 include an upper end opening 22 that opens in an upper surface 21 of the side wall 20 and a lower end opening 24 that opens in a lower surface 23 of the side wall 20. In the present embodiment, two elastic projecting piece insertion holes 26 are formed in each of a back side and a front side of the side wall 20, but any number of elastic projecting piece insertion holes 26 that are separated in a longitudinal direction (left-right direction in FIG. 2) may be provided as necessary. Here, an inner surface 28 of the side wall 20 where the elastic projecting piece insertion holes 26 are formed slightly protrudes toward the inside of the protector body 12. Furthermore, as shown in FIG. 5, an engagement portion 32 having a substantially recessed shape, which is formed by cutting out a portion, on a lower side, of an inner side 30 of the outer wall of the elastic projecting piece insertion hole 26, is provided in the elastic projecting piece insertion hole 26. An upper end surface 34 of the engagement portion 32 is a sloping surface that slopes obliquely downward toward the inside of the protector body 12. Also, as shown in FIGS. 2 and 6, a pair of recessed jig insertion grooves 36 that each have a substantially rectangular cross-sectional shape, open in the upper surface 21 of the side wall 20 of the protector body 12 and the inner side 30 of the outer wall, and extend downward, are formed at both end portions, with respect to the width direction, of an upper end portion of the inner side 30 of the outer wall in which the engagement portion 32 in the elastic projecting piece insertion hole 26 is formed.

Meanwhile, as shown in FIG. 2, the lid 16 is provided with, at its outer edge, a plurality of elastic projecting pieces 38 that each have a substantially rectangular shape, project toward the protector body 12, and are flexible in a plate thickness direction. The lid 16 is, similarly to the protector body 12, integrally formed of synthetic resin such as polypropylene (PP) or polyamide (PA), for example, by injection molding or the like, but is formed separately from the protector body 12. Note that, in the present embodiment, four elastic projecting pieces 38 are formed in correspondence with the elastic projecting piece insertion holes 26 described above.

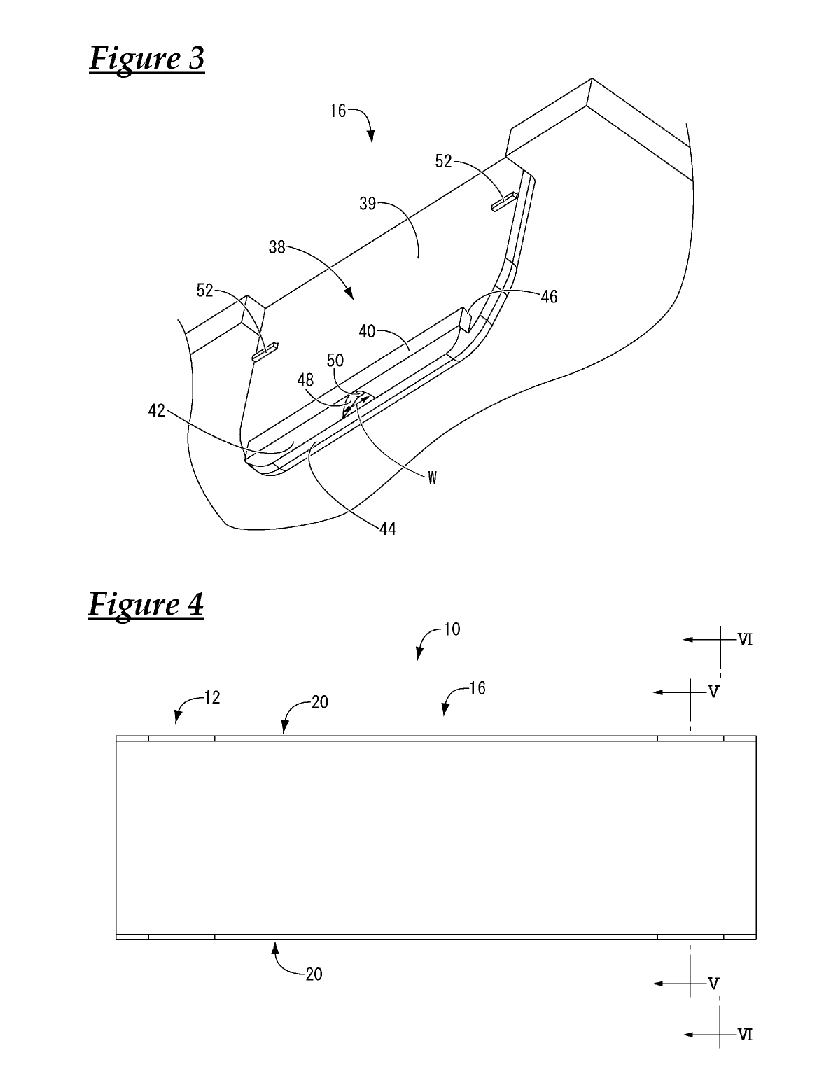

Also, an engagement protrusion 40 that protrudes outward in the plate thickness direction is provided on an outer surface 39 at a leading end of the elastic projecting pieces 38. Furthermore, as shown in FIGS. 3 and 5, a lower end surface 42 of the engagement protrusion 40 is a tapered sloping surface that slopes outward and obliquely upward from a projecting end surface 44 of the elastic projecting piece 38, and an upper end surface 46 of the engagement protrusion 40 is a sloping surface that slopes obliquely downward toward the inside of the protector body 12, similarly to the upper end surface 34 of the engagement portion 32 of the elastic projecting piece insertion hole 26. Also, a recessed jig holding portion 48 having substantially the shape of a truncated half cone is provided in the lower end surface 42, which is a sloping surface, of the engagement protrusion 40, and can accommodate and hold a leading end 56 of a jig 54 having a substantially bar shape that has been inserted from a lower end opening 24 of the elastic projecting piece insertion hole 26, which will be described later. Specifically, as shown in FIG. 3, a bottom portion 50 of the recessed jig holding portion 48 is positioned in a central portion, with respect to a width direction, of the lower end surface 42 of the engagement protrusion 40, and the recessed jig holding portion 48 is formed such that the width W of the recessed jig holding portion 48 increases downward toward the lower end surface 42 of the engagement protrusion 40. Also, as shown in FIG. 5, the bottom portion 50 of the recessed jig holding portion 48 has a sloping bottom surface that is parallel to the lower end surface 42 of the engagement protrusion 40.

Also, as shown in FIGS. 3 and 5, a pair of protrusions 52 that are jig engagement portions, have a substantially rectangular cross sectional shape, and, in a state in which the lid 16 is engaged with the protector body 12, are located below the upper surface 21 of the side wall 20 of the protector body 12, and project toward the inner side 30 of the outer wall in which the engagement portion 32 is provided, are provided at both end portions, with respect to the width direction, of the outer surface 39 of the elastic projecting piece 38, which is a surface opposing the recessed jig insertion groove 36.

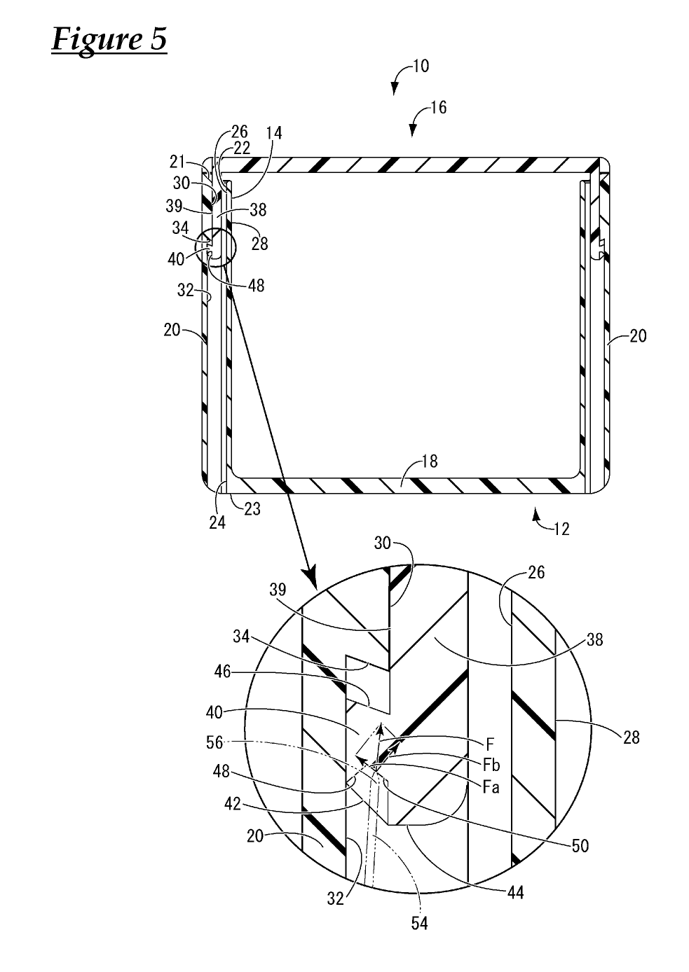

The plurality of elastic projecting pieces 38 of the lid 16 are inserted into the respectively corresponding plurality of elastic projecting piece insertion holes 26 of the protector body 12, the engagement portions 32 of the elastic projecting piece insertion holes 26 are respectively engaged with the engagement protrusions 40 of the elastic projecting pieces 38, and as a result, the lid 16 is fixedly held by the protector body 12, as shown in FIGS. 1 and 4. In this way, in the present embodiment, the locking mechanism is configured by the engagement portions 32 of the elastic projecting piece insertion holes 26 and the engagement protrusions 40 of the elastic projecting pieces 38.

Next, with reference to FIG. 5, the locking mechanism will be described in detail. First, the leading end of the elastic projecting piece 38 of the lid 16 is inserted into the elastic projecting piece insertion hole 26. Because the lower end surface 42 of the engagement protrusion 40 of the elastic projecting piece 38 is a tapered sloping surface, as a result of pushing the leading end of the elastic projecting piece 38 of the lid 16 in a direction toward the protector body 12, the leading end of the elastic projecting piece 38 is inserted into the elastic projecting piece insertion hole 26 while the leading end is pressed toward the inner surface 28 side of the protector body 12, that is, toward a side opposite to the projection side of the engagement protrusion 40, due to an action of the tapered sloping surface. The engagement portion 32 that is formed by cutting out the lower side of the inner side 30 of the outer wall and has a substantially recessed shape is provided in the elastic projecting piece insertion hole 26. Therefore, when the elastic projecting piece 38 is further pushed deep into the elastic projecting piece insertion hole 26 and the engagement protrusion 40 formed at the leading end of the elastic projecting piece 38 passes over the upper end surface 34 of the engagement portion 32, the elastic projecting piece 38 elastically returns, and the engagement protrusion 40 is inserted into the engagement portion 32 of the elastic projecting piece insertion hole 26. Accordingly, the engagement protrusion 40 of the elastic projecting piece 38 is engaged with the engagement portion 32 of the elastic projecting piece insertion hole 26, and the lid 16 is fixedly held by the protector body 12.

On the other hand, to release this engagement state, as shown in FIG. 6, first, the jig 54 is inserted from its leading end 56 side into the recessed jig insertion groove 36 from the upper end opening 22 of the elastic projecting piece insertion hole 26, and the leading end 56 is engaged with a lower surface of the protrusion 52 that constitutes the jig engagement portion, as shown in FIG. 6. Here, the protrusion 52 is provided in the outer surface 39, which is a surface of the elastic projecting piece 38 that opposes the recessed jig insertion groove 36. In this way, as a result of the leading end 56 of the jig 54 being engaged with the lower surface the protrusion 52, a lever can be configured in which the abutting part between the leading end 56 of the jig 54 and the protrusion 52 acts as a point of load, the abutting part between the jig 54 and the side wall 20 acts as a fulcrum, and the base end of the jig 54 acts as a point of effort. Accordingly, by merely pushing the base end of the jig 54 downward, the engagement protrusion 40 of the elastic projecting piece 38 can be easily elastically deformed so as to separate from the engagement portion 32. Note that to facilitate understanding, in FIGS. 5 and 6, the jig 54 is depicted by phantom lines.

Also, to release such an engagement state, as shown in FIG. 5, furthermore, a substantially bar-shaped jig 54 may be inserted substantially upward in the vertical direction from the lower end opening 24 of the elastic projecting piece insertion hole 26 from the leading end 56 side, and the leading end 56 may be accommodated and held in the recessed jig holding portion 48 formed in the lower end surface 42 of the engagement protrusion 40. The leading end 56 of the jig 54 is pushed further upward in this state, and an auxiliary force F is applied to the bottom portion 50 of the recessed jig holding portion 48. Here, because the bottom portion 50 of the recessed jig holding portion 48 is a sloping bottom surface that is parallel to the lower end surface 42 of the engagement protrusion 40, the auxiliary force F can be decomposed into a component force Fa that presses the engagement protrusion 40 outward and obliquely upward and a component force Fb that is larger than the component force Fa and presses the engagement protrusion 40 inward and obliquely upward. Therefore, the auxiliary force from the jig 54 can be advantageously exerted to the engagement protrusion 40 such that the engagement protrusion 40 is separated from the engagement portion 32 and the engagement protrusion 40 is disengaged from the engagement portion 32 by the larger component force Fb.

According to the wire housing protector 10 of the present embodiment having such a structure, the pair of recessed jig insertion grooves 36 that each have a substantially rectangular cross-sectional shape, open in the upper surface 21 of the side wall 20 of the protector body 12, and extend downward are formed at both end portions in the width direction of the upper end portion of the inner side 30 of the outer wall in which the engagement portion 32 in the elastic projecting piece insertion hole 26 is formed. Furthermore, the pair of protrusions 52 that are part of a jig engagement portion, each have a substantially rectangular cross sectional shape, and are located below the upper surface 21 of the side wall 20 of the protector body 12, and project toward the inner side 30 of the outer wall in which the engagement portion 32 is provided, are provided in both end portions in the width direction of the outer surface 39, which is a surface opposing the recessed jig insertion groove 36, of the elastic projecting piece 38. Therefore, as a result of the leading end 56 of the jig 54 being inserted into the recessed jig insertion groove 36 from the upper end opening 22 of the elastic projecting piece insertion hole 26 and being engaged with the protrusion 52, a lever can be configured in which the abutting part between the leading end 56 of the jig 54 and the protrusion 52 acts as a point of load, the abutting part between the jig 54 and the side wall 20 acts as a fulcrum, and the base end of the jig 54 acts as a point of effort. Accordingly, by merely applying an auxiliary force that is generated by pushing the base end of the jig 54 downward, the engagement protrusion 40 of the elastic projecting piece 38 can be easily elastically deformed so as to separate from the engagement portion 32. In this way, even if the engagement portion 32 and the engagement protrusion 40 that constitute the locking mechanism is provided inside the side wall 20 of the protector body 12, the locking mechanism can be easily released, and the lid 16 can be separated from the protector body 12 without breaking the locking structure.

Also, relative to the protrusion 52, which is a jig engagement portion, the leading end 56 of the jig 54 is arranged under the protrusion 52 such that the leading end 56 can be hooked to the lower surface of the protrusion 52. Accordingly, the jig 54 can be stably held between the upper surface 21 of the side wall 20 of the protector body 12 and the lower surface of the protrusion 52, and as a result, the force based on the principle of the lever can be more effectively exerted to the elastic projecting piece 38. Furthermore, since the engagement protrusion 40 is originally provided in the outer surface 39, which is an opposing surface of the elastic projecting piece 38, the protrusion 52 can be easily formed in the opposing surface of the elastic projecting piece 38 from a viewpoint of the mold configuration.

Furthermore, the pair of recessed jig insertion grooves 36 are provided at both ends in the width direction of the inner side 30 of the outer wall in the elastic projecting piece insertion hole 26, and the pair of protrusions 52, which constitute the jig engagement portions, are provided at both end portions in the width direction of the elastic projecting piece 38. Accordingly, an auxiliary force by the jig 54 can be exerted on both sides in the width direction of the elastic projecting piece 38, and therefore an elastic deformation of the elastic projecting piece 38 that separates the engagement protrusion 40 from the engagement portion 32 can be stably applied overall, and the engagement protrusion 40 can be separated from the engagement portion 32 more securely.

In addition, since the elastic projecting piece insertion hole 26 includes the lower end opening 24 that opens in the lower surface 23 of the side wall 20, the engagement protrusion 40 of the elastic projecting piece 38 can be accessed from the lower end opening 24 of the elastic projecting piece insertion hole 26. Also, the recessed jig holding portion 48 is provided in the lower end surface 42 of the engagement protrusion 40, and as a result, the leading end 56 of the jig 54 that has been inserted from the lower end opening 24 of the elastic projecting piece insertion hole 26 described above is stably accommodated and held in the recessed jig holding portion 48. Therefore, an auxiliary force that is applied via the jig 54 can be stably transmitted to the engagement protrusion 40 of the elastic projecting piece 38. Furthermore, the bottom portion 50 of the recessed jig holding portion 48 is a sloping bottom surface that is parallel to the lower end surface 42 of the engagement protrusion 40, and as a result, the auxiliary force from the jig 54 can be advantageously exerted such that the engagement protrusion 40 is separated from the engagement portion 32 by using the component force Fb of the force F that is applied via the jig 54. In this way, even if the engagement portion 32 and the engagement protrusion 40 that constitute the locking mechanism is provided inside the side wall 20 of the protector body 12, the locking mechanism can be easily released, and the lid 16 can be separated from the protector body 12 without breaking the locking structure. As a result, the combination of the auxiliary force from above the elastic projecting piece 38 via a jig 54 and the auxiliary force from below the elastic projecting piece 38 via a jig 54 makes it possible to more easily release the locking mechanism.

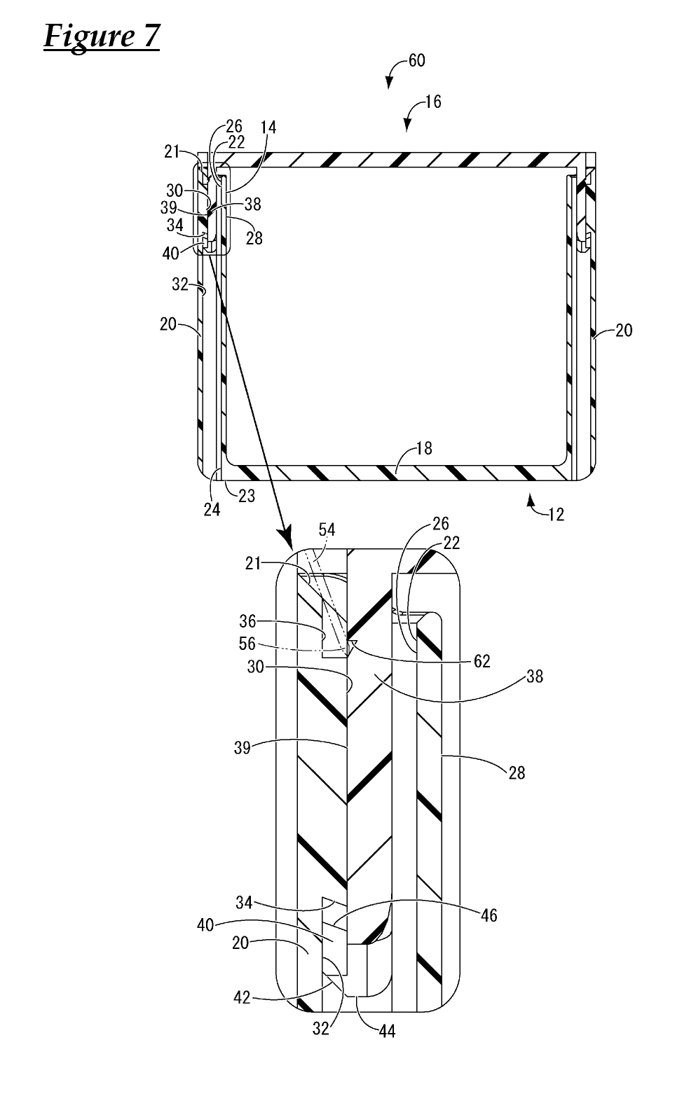

Next, a wire housing protector 60 according to a second embodiment will be described in detail with reference to FIG. 7. Members and portions having a structure similar to those in the above embodiment will be denoted in this diagram by the same reference signs as in the above embodiment, thereby omitting detailed descriptions for them. The wire housing protector 60 according to the second embodiment is different from the wire housing protector 10 according to the first embodiment in that the jig engagement portion is configured to include a recess 62 having a substantially triangular cross-sectional shape that opens in the outer surface 39, which is a surface of the elastic projecting piece 38 opposing the recessed jig insertion groove 36.

According to the present embodiment, the jig engagement portion is configured to include the recess 62, and as a result, the jig engagement portion can be formed while reducing the material cost. Furthermore, the jig engagement portion can be configured by arranging the recess 62 of the present embodiment in the lower surface of the protrusion 52 described in the aforementioned first embodiment. In this case, as a result of arranging the recess 62 in the lower surface of the protrusion 52, the depth of engagement between the jig engagement portion and the leading end 56 of the jig 54 can be enlarged, and therefore, the engagement retainability of the jig 54 can be improved as well.

Although embodiments of the present design have been described in detail above, the present invention is not limited by these specific descriptions. For example, in the embodiments described above, the pair of recessed jig insertion grooves 36 and the pair of protrusion 52 are provided, but the number thereof is not limited to a pair, and any number thereof can be adopted. In addition, any shape can be adopted for the recessed jig insertion groove 36 and the jig engagement portions 52 and 62 as long as the leading end 56 of a jig 54 can be inserted thereto and be engaged therewith. Also, a recessed jig holding portion 48 having substantially the shape of a truncated half cone is provided in the central portion in the width direction of the lower end surface 42 of the engagement protrusion 40, but any number of recessed jig holding portions having any shape may be provided at any position in the lower end surface 42 of the engagement protrusion 40, as long as each recessed jig holding portion can accommodate and hold the leading end 56 of a jig 54. In addition, in the embodiments described above, the bottom portion 50 of the recessed jig holding portion 48 is a sloping bottom surface that is parallel to the lower end surface 42 of the engagement protrusion 40, but a bottom portion having any shape can be adopted as long as an external force from the jig 54 can be exerted to the engagement protrusion 40 in a direction such that the engagement protrusion 40 is separated from the engagement portion 32.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

10, 60: Wire housing protector
12: Protector body
14: Upper opening
16: Lid
20: Side wall
21: Upper surface
23: Lower surface
24: Lower end opening
26: Elastic projecting piece insertion hole (locking mechanism)
30: Inner side of outer wall (surface in which engagement portion is formed)
32: Engagement portion
36: Recessed jig insertion groove
38: Elastic projecting piece (locking mechanism)
40: Engagement protrusion
42: Lower end surface (sloping surface)
44: Projecting end surface
48: Recessed jig holding portion
52: Protrusion (jig engagement portion)
54: Jig
56: Leading end
62: Recess (jig engagement portion)

1. A wire housing protector comprising:
a protector body extending in the shape of a trough;
a lid for covering an upper opening of the protector body; and
a locking mechanism for fixedly holding the protector body and the lid,
wherein the locking mechanism includes:
an elastic projecting piece that protrudes from the lid and is provided with an engagement protrusion at its leading end; and
an elastic projecting piece insertion hole that passes through the inside of a side wall of the protector body and opens in an upper surface of the side wall, and includes an engagement portion that engages with the engagement protrusion,
wherein the wire housing protector is configured such that the elastic projecting piece can be inserted into the elastic projecting piece insertion hole while the leading end of the elastic projecting piece is pressed toward a side opposite to a side to which the engagement protrusion protrudes, and when the elastic projecting piece elastically returns, the engagement protrusion engages with the engagement portion and the lid is held by the protector body,
wherein a recessed jig insertion groove that opens in the upper surface of the side wall of the protector body and extends downward is formed in a surface in which the engagement portion is formed in the elastic projecting piece insertion hole, and
wherein a jig engagement portion that is located below the upper surface of the side wall of the protector body and which engages a leading end of a jig that has been inserted into the recessed jig insertion groove is provided in an opposing surface of the elastic projecting piece that opposes the recessed jig insertion groove.

2. The wire housing protector according to claim 1, wherein the jig engagement portion includes a protrusion that protrudes from the opposing surface of the elastic projecting piece toward the surface in which the engagement portion is formed.

3. The wire housing protector according to claim 1, wherein the jig engagement portion includes a recess that opens in the opposing surface of the elastic projecting piece.

4. The wire housing protector according to claim 1, wherein a pair of the recessed jig insertion grooves are provided at both ends in a width direction of the surface in which the engagement portion is formed in the elastic projecting piece insertion hole, and a pair of the jig engagement portions are provided at both end portions in a width direction of the elastic projecting piece.

5. The wire housing protector according to claim 1,
wherein the elastic projecting piece insertion hole is formed so as to pass through the inside of the side wall of the protector body in a height direction, and a lower end opening of the elastic projecting piece insertion hole opens in a lower surface of the side wall, and
the engagement protrusion of the elastic projecting piece includes a sloping surface that slopes obliquely upward from a projecting end surface of the elastic projecting piece, and a recessed jig holding portion is provided in the sloping surface so as to accommodate and hold a leading end of a jig that has been inserted from the lower end opening of the elastic projecting piece insertion hole.
